(19) United States
(12) Patent Application Publication
(10) Pub. No.: US 2008/0267399 A1
(43) Pub. Date: Oct. 30, 2008

(54) Method and Apparatus for Secure Content Recording

(75) Inventors: Alexander Medvinsky, San Diego, CA (US); Petr Peterka, San Diego, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/851,066

(22) Filed: Sep. 6, 2007

Related U.S. Application Data
(60) Provisional application No. 60/914,446, filed on Apr. 27, 2007.

(51) Int. Cl. H04N 7/167; H04L 9/00

(52) U.S. Cl. 380/201; 380/44

(57) ABSTRACT

A method is provided that establishes a secure tunnel with a content acquisition processor that acquires encrypted content from a content source and decrypts the encrypted content to obtain content. The content acquisition processor is not trusted for providing digital rights management. Further, the method transmits a request through the secure tunnel to the content acquisition processor to re-encrypt the content with a content encryption key so that re-encrypted content is generated and stores the re-encrypted content on a storage medium. The request includes the content encryption key.

### RELATED APPLICATIONS

This application claims priority to U.S. Provisional Application Ser. No. 60/914,446 entitled “Secure Content Recording in a 2-Processor Architecture,” filed on Apr. 27, 2007, the content of which is incorporated herein by reference in its entirety.

### BACKGROUND

1. Field

This disclosure generally relates to the field of audio/visual content. More particularly, the disclosure relates to security for a device that stores audio/visual content.

2. General Background

Content providers, e.g., cable providers, have conventionally utilized a cable line for transmission of audio/visual content to a set top box that is connected to a television in a user's home. Recent efforts have been made to provide security mechanisms on the content that content providers provide. For instance, a set top box receiving content from a cable provider may have an embedded security mechanism within the set top box to encrypt incoming content that is recorded on the set top box. Further, the cable provider may encrypt the content that is sent to the set top box. A variety of configurations may be utilized to protect content coming from a source, e.g., a content provider, a memory module, etc.

A current approach configures set top box environments to be conditional access (“CA”) systems, which only allow access of the audio/visual content to an authorized user. An encryption mechanism is normally utilized to implement the CA. As a result, copy protection (“CP”) is ensured so that an unauthorized user is prevented from making a copy of the audio/visual content. However, the introduction of removable Conditional Access (“CA”) module, e.g., CableCARD®, has raised security concerns regarding the transfer of content from the CA module to the set top box.

Further, current approaches do not define how to provide adequate security for recording content in a multi-processor architecture where some of the processors may not be secure enough to implement a digital rights management system. For instance, one current approach provides for encrypting content that is transmitted from the CA module, but does not support recording. Further, another current approach provides for secure recording of content in a set top box, but requires that the CA module is also present during playback.

### SUMMARY

In one aspect of the disclosure, a process may be utilized by a DRM processor. The process establishes a secure tunnel with a content acquisition processor that acquires encrypted content from a content source and decrypts the encrypted content to obtain content. The content acquisition processor is not trusted for providing digital rights management. Further, the process transmits a request through the secure tunnel to the content acquisition processor to re-encrypt the content with a content encryption key so that re-encrypted content is generated and stores the re-encrypted content on a storage medium. The request includes the content encryption key.

In another aspect of the disclosure, a process may be utilized by a content acquisition processor. The process establishes a secure tunnel with a DRM processor that is trusted for maintaining a digital rights management system. Further, the process receives encrypted content from a content source. In addition, the process decrypts the encrypted content to obtain content. Finally, the process receives, from the DRM processor through the secure tunnel, a request to re-encrypt the content with a content encryption key and stores the re-encrypted content on a storage medium, the request including the content encryption key

In yet another aspect of the disclosure, a process may be utilized by the set top box. The process establishes a secure tunnel between a DRM processor that is trusted for maintaining a digital rights management system and a content acquisition processor that is not trusted for maintaining the digital rights management system. Further, the process receives, at the content acquisition processor, encrypted content from a content source. In addition, the process decrypts, at the content acquisition processor, the encrypted content to obtain content. Finally, the process transmits a request from the DRM processor through the secure tunnel to the content acquisition processor. The request is to re-encrypt the content with a content encryption key and store the re-encrypted content on a storage medium, the request including the content encryption key.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a set top box configuration environment.

FIG. 2 illustrates a configuration that utilizes a plurality of processors to provide secure content recording.

FIG. 3 illustrates a timing configuration of CCI and key changes between the DRM processor and the content acquisition processor.

FIG. 4 illustrates a process that may be utilized by a DRM processor.

FIG. 5 illustrates a process that may be utilized by a content acquisition processor.

FIG. 6 illustrates a process that may be utilized by the set top box.

FIG. 7 illustrates a block diagram of a station or system that provides secure content recording.

### DETAILED DESCRIPTION

A method and apparatus are disclosed that provide for secure recording of content. In one embodiment, a multi-chip architecture includes a processor dedicated to acquiring content and a processor dedicated to playback of the content. Further, the utilization of these two processors allows playback of securely recorded content without the presence of a device such as the CableCARD®.

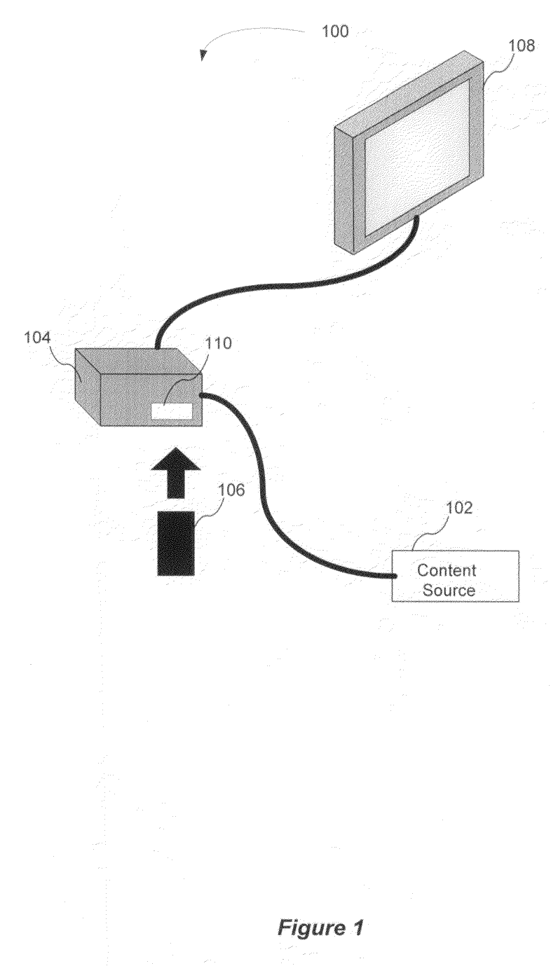

FIG. 1 illustrates a set top box configuration environment 100. A content source 102, such as a content provider, encrypts a set of content and then sends the content through a transmission line, e.g., a cable, to a set top box 104. If the content is encrypted, the set top box 104 sends the content to a content protection module 106 for decryption. Examples of the content protection module 106 include a CableCARD®, smart card, on-board security chip, etc. However, any component that has the capability of terminating conditional access that was protecting content transmitted to a set top box 104 and applying copy protection when sending the content to the set to box 104 may be considered a content protection module 106. Further, the content source 102 may include the content protection module 106. In other words, a single module may be both the content source 102 and the content protection module 106. For instance, a CA module that is inserted into the set top box 104 may store content and provide conditional access. Further, the set top box 104 is utilized as an example, and one of ordinary skill in the art will recognize that any type of device, such as a mobile phone, television with a built-in slot for a CableCARD®, etc., may be utilized. The content protection module 106 then decrypts the content. Further, in one embodiment, the content protection module 106 has an interface so that it may fit into a slot 110 of a set top box 104 and communicate with the set top box 104.

The method and apparatus provide a robust approach for the set top box 104 to decrypt the encrypted content received from the content protection module 106 and re-encrypt the content so that the content cannot be copied off of a hard drive associated with the set top box 104 if the set top box 104 stores the content, e.g., if the set top box has a Personal Video Recorder (“PVR”). The content may then be decrypted by the set top box 104 and sent to a display 108, e.g., a television, a monitor, etc., for viewing. Re-encryption is also utilized when the content is not recorded, but displayed directly, so that clear content is prevented from being transferred between chips in an unprotected manner.

In one embodiment, the set top box 104 may have one or more additional connections other than to the content source 102 to allow for the reception of additional content. For instance, the set top box 104 may have a broadband connection to receive content from the Internet. Further, the set top box 104 may allow a user to download a movie from an Internet provider rather than the content source 102, e.g., a cable content provider.

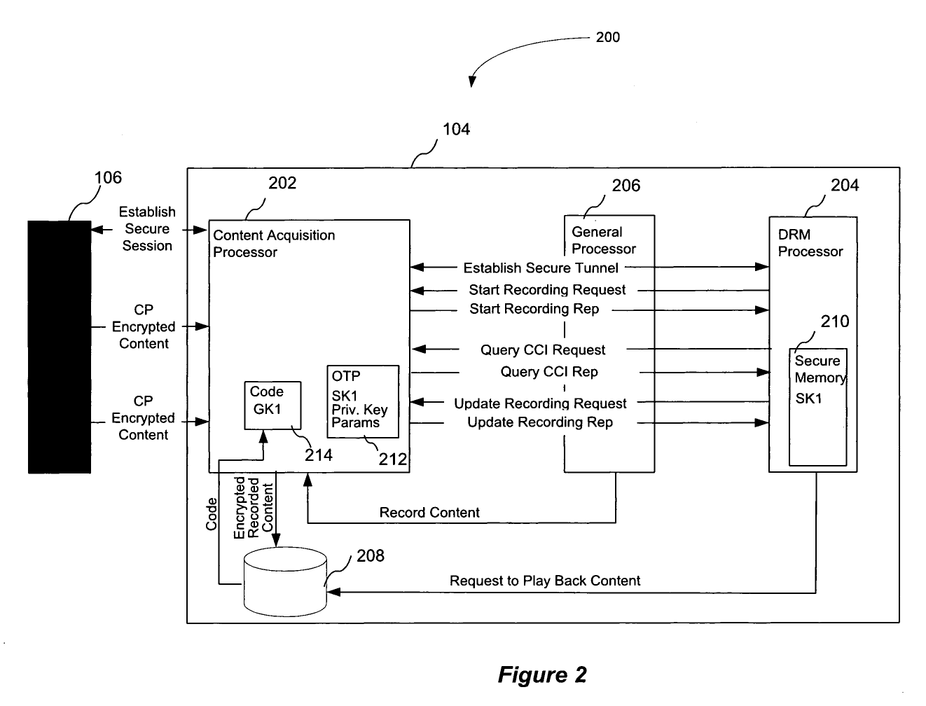

FIG. 2 illustrates a configuration 200 that utilizes a plurality of processors to provide secure content recording. For instance, the set top box 104 may have a content acquisition processor 202, a Digital Rights Management (“DRM”) processor 204, and a general processor 206. Further, the set top box 104 may have a storage device 208, e.g., a hard drive, a memory, etc., to store the content.

The content acquisition processor 202 is responsible for the interface and establishment of a secure session with the content protection module 106. Further, the content acquisition processor 202 may decrypt and forward an A/V stream, e.g., an MPEG-2 transport stream, for the purpose of recording to the hard drive 208 or to a hard drive associated with the general processor 206. In addition, the content acquisition processor 202 transcodes content already stored on the hard drive 208. In other words, the content acquisition processor 202 converts the content into a different format if the content is going to be transferred to another device, e.g., a handset, that supports a different content format. In that event, a transcoded copy of the content is created first and then transferred to the other device. At the time that a user would like to view the recorded content, the DRM processor 204 obtains the content directly, or indirectly, through the general processor 206, from the hard drive 208. The DRM processor 204 then utilizes the DRM system running on the DRM processor 204 to obtain the one or more decryption keys from the DRM license to decrypt the content for viewing. Further, the content may be inserted into the set top box 104 through a removable media storage device, e.g., a pluggable memory. The content acquisition processor 202 may need to transcode the content in a similar manner in this instance, i.e., if the content stored on the removable media storage device is in a format that cannot be played back on the current device.

The DRM processor 204 is a video processor that provides local content playback, i.e., decrypting an A/V stream received from the content acquisition processor 202. Further, the DRM processor 204 is responsible for the DRM for the content stored on the hard drive 208 in the set top box 104 by the content acquisition processor 202. As the bandwidth for communication between the DRM processor 202 and the content acquisition processor 202 is limited, the DRM responsibility of the DRM processor 202 is configured to allow the DRM processor 202 to control the digital rights of content without actually having to receive the content. By providing the DRM responsibility to the DRM processor 202 and the original content acquisition and recording responsibilities to the content acquisition processor 204, the configuration 200 prevents a compromised content acquisition processor 204 from further compromising the DRM keys, e.g., the device private key, utilized in the secure content exchanges with other devices. Further, in one embodiment, the DRM responsibility of the DRM processor 202 allows the DRM processor 202 to reject communications from the content acquisition processor 204 if the content acquisition processor 204 is running an old version of its software, which may be an indication that the security of the content acquisition processor 204 is not as robust as it should be or that the content acquisition processor 204 is compromised. Further, the content acquisition processor and its associated software may be implemented without any knowledge of the DRM system that is applied to recorded content. Accordingly, the DRM processor 204 and/or the content acquisition processor 202 may be implemented as a removable module, e.g., USB dongle, PCMCIA card, etc. Therefore, the CA system for initial content acquisition may be replaced without affecting the DRM system. Conversely, the DRM system may be replaced without affecting the currently utilized CA system.

The content acquisition processor 202 and the DRM processor 204 may communicate through the general processor 206, which basically passes through information between the content acquisition processor 202 and the DRM processor 204. In an alternative embodiment, the content acquisition processor 202 and the DRM processor 204 may communicate directly with one another.

In one embodiment, the configuration 200 has an established protocol for communications between the plurality of processors in the multi-chip architecture. The DRM processor 204 establishes a secure tunnel, which is encrypted and authenticated, with the content acquisition processor 202. The establishment of the secure tunnel may be initiated by the DRM processor 204 prior to the establishment of the secure session with the content protection module 106, i.e., prior to the connection of the content protection module 106 to the set top box 104.

The DRM processor 204 may request that a program be recorded by the content acquisition processor 202 on the hard drive 208. Further, the DRM processor 204 includes a PVR content key in the request. Accordingly, the content acquisition processor 202 re-encrypts decrypted content with the PVR content key and stores the re-encrypted content on the hard drive 208. In addition, the DRM processor 204 asynchronously listens to Copy Control Information (“CCI”) updates that the content acquisition processor 202 may receive from the content protection module 106, i.e., receives the CCI updates through the secure tunnel from the content acquisition processor 202 and provides the content acquisition processor 202 with the updated PVR encryption keys. The CCI provides information as to the types of operations that are allowed on the transferred content. For instance, the CCI may include information such as whether the user is authorized to make a copy. Extended CCI information may also be delivered to indicate number of copies, number of playbacks, rental period and other rights or restrictions. The content acquisition processor 202 utilizes the secure tunnel to communicate the CCI changes to the DRM processor 204 running the DRM system. In response, the DRM processor 204 generates a new set of unique encryption keys to be applied by the content acquisition processor 202 during the re-encryption process and sends them utilizing the secure tunnel back to the content acquisition processor 202. The generation of the encryption key may include the CCI value to ensure that CCI values are cryptographically bound to the encrypted content. Accordingly, the content acquisition processor 202 utilizes the updated PVR encryption keys to record the subsequent re-encrypted content.

The secure tunnel is established by utilizing a shared symmetric key (“SK1”) to encrypt messages between the DRM processor 204 and the content acquisition processor 202. In one embodiment, the SK1 is preloaded on the content acquisition processor 202 and the DRM processor 204 so that the secure tunnel may be established. For instance, the content acquisition processor 202 and the DRM processor 204 may be preloaded in the factory with the SK1 into secure non-volatile memory on both the DRM processor 204 and the content acquisition processor 202.

As an example of a code encryption/authentication process, a global key (“GK1”) is also utilized in the procedure for establishing the secure tunnel. In one embodiment, the GK1 is hard coded in code 214 that is loaded on to the content acquisition processor 202. The code 214 is encrypted so that the GK1 is secure in the content acquisition processor 202. In addition to being encrypted, the code 214 is authenticated by the bootloader using standard techniques such as a digital signature or a Message Authentication Code (“MAC”). Since the code 214 is not decrypted while on the hard drive 208, an intruder is unable to retrieve the unencrypted code. Further, if an intruder attempts to load his or her own unencrypted code on to the content acquisition processor 202, the unencrypted code will not have the GK1 key. Each time a secure tunnel is established, a session key is derived from the SK1, which is encrypted by the GK1. If the content acquisition processor 202 is not at the time executing the correct code 214, the content acquisition processor 202 cannot decrypt the SK1 and eventually fails authenticating to the DRM processor 204. The session key is utilized for the secure transmission of messages through the secure tunnel. One of ordinary skill in the art will understand that alternative code encryption/authentication processes may be utilized.

The configuration 200 stores the GK1 only in the content acquisition processor 202. Without the correct GK1, the content acquisition processor 202 is unable to establish a secure tunnel with the DRM processor 202. Further, without the correct private key (also stored encrypted with the GK1), the content acquisition processor 202 would be unable to communicate with the content protection module 106. In one embodiment, two layers of encryption may be utilized. The outer layer may be a unique per chip key. Further, the inner layer key, i.e., the GK1, may be hidden in the encrypted code image and utilized to indirectly authenticate the code image.

While the GK1 is utilized to encrypt the private key, the SK1, and other permanent keys in the content acquisition processor 202, a device-unique key may be utilized to double-encrypt all of those values. The device-unique key is unique to the particular set top box 104. Accordingly, copying the encrypted keys to another device will be ineffective as another device will have a different device unique key. The GK1 is in the encrypted code image. If an intruder attempts to replace the code 214 with a different set of code not having the GK1, the intruder will not be able to access any of the stored keys.

In one embodiment, the secure tunnel keys utilized between the content acquisition processor 202 and the DRM processor 204 are derived from SK1, a shared secret derived through a key agreement algorithm, e.g., Diffie-Hellman, and a counter. The SK1 is permanent to each device and the shared secret does not change until the next reboot, but the counter could be changed. Every time the DRM processor 204 increments the counter, a new set of secure tunnel keys has to be re-derived. Accordingly, the content acquisition processor 202 is forced to also re-derive the new set of secure tunnel keys. This updating of the secure tunnel keys is utilized in case the old set of secure tunnels keys is somehow leaked or to minimize the time window for brute force attacks. Each time that the secure tunnel keys are re-derived, the content acquisition processor 202 is forced to load an encrypted SK1 value into memory and decrypt it twice: first with a device-unique key and then with GK1. If the code was somehow replaced in memory while the content acquisition processor 202 was running, it will not have the GK1 value to be able to re-derive the secure tunnel keys.

Further, the DRM processor 204 may force the content acquisition processor 202 to provide the code version number of the code 214 stored in the content acquisition processor 202 during the secure tunnel establishment. The DRM processor 204 would store the smallest acceptable code version of the code 214 stored in the content acquisition processor 202. Code versions that are too low are generally associated with non-secure code that has one ore more security flaws. If the DRM processor 204 finds that the code version of the code 214 stored in the content acquisition processor 202 is too low, the DRM processor 204 rejects the code version, and a secure tunnel is not successfully established.

Establishment of Secure Tunnel

The establishment of the secure tunnel shall now be discussed. The DRM processor 204 initiates a set of keys that are utilized for the secure tunnel between the DRM processor 204 and the content acquisition processor 202 so that the DRM processor 204 and the content acquisition processor 202 may communicate securely. Further, the keys may be updated periodically.

The establishment of the secure tunnel begins with the DRM processor 204 sending a request to the content acquisition processor 202 to establish a secure tunnel. In one embodiment, the request is an authenticated message carrying a DRM processor 204 Diffie-Hellman public key g^{x} mod p. The content acquisition processor 202 then sends a request to the DRM processor 204 to establish the secure tunnel. In one embodiment, the reply is an authenticated message carrying a content acquisition processor 202 Diffie-Hellman public key g^{y} mod p. This message contains the current code version number of the code 214. The DRM processor 204 may reject the code version number on the basis that it has been revoked. After this message is validated and accepted by the DRM processor 204, both sides possess a shared secret that may be utilized to encrypt and authenticate messages between the two processors.

The keys may include a tunnel authentication key (“TAK”) and a tunnel encryption key (“TEK”). Both TAK and TEK may be derived using a secure one-way function from the following information: a shared key established through key agreement, e.g., Diffie-Hellman, counter value and SK1. Further, the counter may be the value found in each message header. If this value is greater than the one in the previously received message, and the new message is protected utilizing the tunnel keys, then the tunnel keys are re-derived. If the counter value is less than a previously observed value, the message is discarded as a replay.

In one embodiment, both the TAK and the TEK are one hundred twenty eight bit Advanced Encryption Standard (“AES”) keys. Further, in one embodiment, the SK1 may be a one hundred sixty bit HMAC-SHA1 key that is pre-provisioned into both the secure memory of the content acquisition processor 202 and the secure memory of the CPU of the DRM processor 204 in the factory. In addition, the shared key may be a one thousand twenty four bit value that is calculated as g^{xy}, which is a Diffie-Hellman shared secret established during the Establish Secure Tunnel request and reply transaction. In order for the content acquisition processor 202 to re-derive new tunnel keys for a new counter value, the content acquisition processor 202 obtains the encrypted value of SK1 again from the disk and decrypts it before applying the key derivation function. In one embodiment, to minimize delays, the DRM processor 204 only changes the counter value when sending back an acknowledgement, e.g., when acknowledging a CCI change.

In one embodiment, the DRM processor 204 may be configured to require the version of the code 214 stored in the content acquisition processor 202 to be larger than a particular value. If the condition is met, both the DRM processor 204 and the content acquisition processor 202 establish the same value of DHKey through a key agreement algorithm. If the condition is not met, the DRM processor 204 sends a termination content protection module message to the content acquisition processor 202. Further, the DRM processor 204 stops any further communication with the content acquisition processor 202. If this condition is not met, the content acquisition processor 202 may upgrade its code image, which does not require the participation of the CPU of the DRM processor 204. Upon a reboot of the set top box 104 or other device, the condition will be cleared and communication between the DRM processor 204 and the content acquisition processor 204 may resume.

### Content Recording Messages

The protocol messages associated with content recording shall now be discussed. The DRM processor 204 may send the content acquisition processor 202 an update recording request message. This message includes a content encryption key and some information provided by an application. The content acquisition processor 202 does not initiate any content recording until this message is received. The content key provided by the DRM processor 204 at the start of a recording is derived from the default CCI settings. This message may optionally be sent periodically by the DRM processor 204 for the same recording to derive new content encryption key based on a new timestamp. Accordingly, each segment can be expired after a predetermined time interval as is sometimes required for copy-never content.

This message may also be sent as a response to the Update CCI Request. If after a predetermined time period after detection of a CCI change, the content acquisition processor 202 has not yet received this message or has not yet applied the new content encryption key, the content acquisition processor 202 either terminates or temporarily pauses the recording until the new content encryption key is obtained and activated. This is done to make sure that CCI changes are not ignored accidentally or on purpose by someone illicitly trying to make additional copies of the content.

Further, the content acquisition processor 202 may send an update recording reply to the DRM processor 204. In one embodiment, the update recording reply is an acknowledgement of the corresponding request message. If this acknowledgement message is not received by the DRM processor 204 within a predetermined time period, the DRM processor 204 marks the corresponding content license as invalid and ignores any further requests from the content acquisition processor 202 to update the CCI. This is done to make sure new keys are not ignored by accident or on purpose by someone illicitly trying to extend CCI for one section of the content to the rest of the content. For example, an adversary may attempt to extend CCI equaling copy free associated with a five minute commercial to the rest of the recording that includes a whole movie. In one embodiment, the update recording request could itself be in reply to an update CCI request, which results in a three-way message exchange.

In addition, the content acquisition processor 202 may send an update CCI request message to the DRM processor 204. In one embodiment, the DRM processor 204 sends the CCI, extended CCI, a High Definition (“HD”) flag, or any other DRM-related attributes associated with a program being recorded. The content acquisition processor 202 specifies HD=one (true) for content that is considered to be High Definition. The HD flag is necessary when content restrictions require that any additional copies of that content are made in reduced resolution. As a result, a new DRM license section is created. The content acquisition processor 202 sends this message whenever either CCI changes or the video resolution changes between high definition and standard definition, or both changes occur at the same time.

Timing of CCI and Key Changes

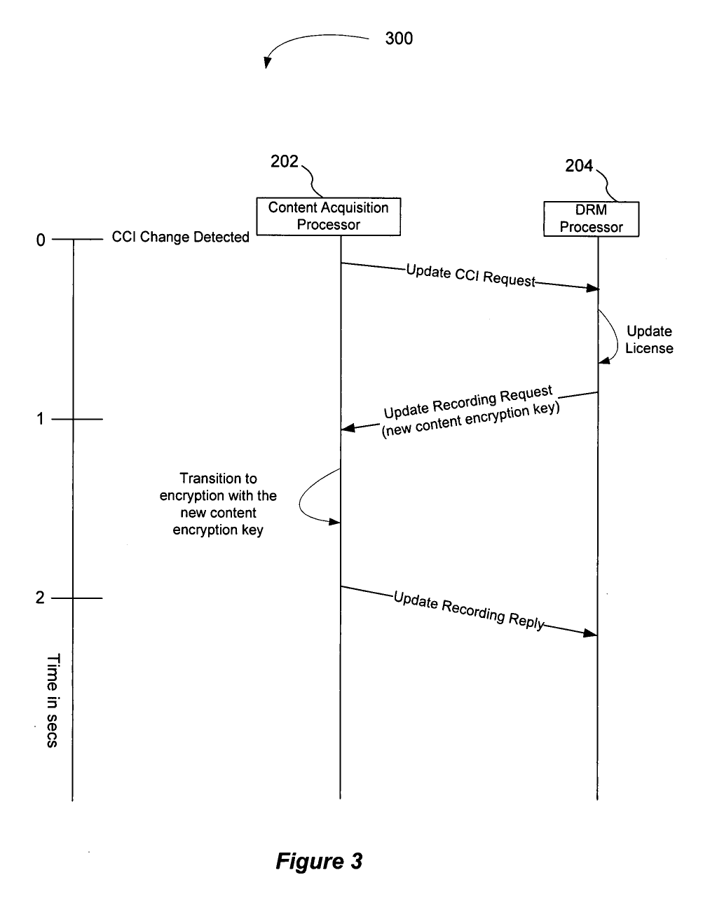

The timing of CCI and key changes shall now be discussed. FIG. 3 illustrates a timing configuration 300 of CCI and Key Changes between the DRM processor 204 and the content acquisition processor 202.

In one embodiment, a predetermined time period of each recording may be in the clear to speed up channel changes or channel acquisition. This occurs even if the corresponding transport packets obtained via the interface of the content protection module 106 were originally encrypted. After the initial period, the content acquisition processor 202 begins encrypting the transport packets, e.g., MPEG-2 transport packets, utilizing the key obtained from the Update Recording Request message.

In the middle of the recording, the DRM processor 204 periodically sends updates to the DRM content encryption key in the Update Recording Request message. The new content encryption key is derived from a new timestamp. Each content key is associated with a timestamp, typically used to enforce pause buffer limit of copy-never content. The content acquisition processor 202 applies the new content encryption key immediately and updates the odd/even indicator in the transport headers according to the value supplied in the Update Recording Request. If the odd/even indicator cannot be used, the transition between two encryption keys may be assisted by a short period of time, e.g. one second, when content is kept unencrypted to allow the encryptor to switch from one key to another seamlessly. In other content transport formats, a complete Key ID may be utilized instead of just an odd/even key indicator.

If the content acquisition processor 202 detects a CCI change, then it sends a message to the DRM processor 204 with the new CCI values. Upon successful validation of this message, the DRM processor 204 replies to the content acquisition processor 202 to with a new content encryption key. Between the time that the content acquisition processor 202 has detected a CCI change and the time that it started encrypting with the new content encryption key, which corresponds to new CCI values, more than a predetermined time period shall not elapse. If the content acquisition processor 202 does not receive the Update Recording Request in time to apply the new content encryption key before the 2 sec timeout, the content acquisition processor 202 temporarily stops recording until the new content encryption key is obtained. The result would be a recording that is missing part of the content two seconds subsequent to a CCI change.

In one embodiment, the content acquisition processor 202 may be utilized as a content acquisition processor that acquires content from the content protection module 106. Further, in one embodiment, the DRM processor 204 may be utilized as a digital rights management processor that utilizes a digital rights management system for the content that is obtained by the content acquisition processor. The DRM system may securely maintain the encryption keys, their expiration times and corresponding CCI values associated with each recording for later playback. The DRM processor 204 may also be a playback processor that may access the encrypted content on the hard drive 208 to play it back utilizing the DRM system.

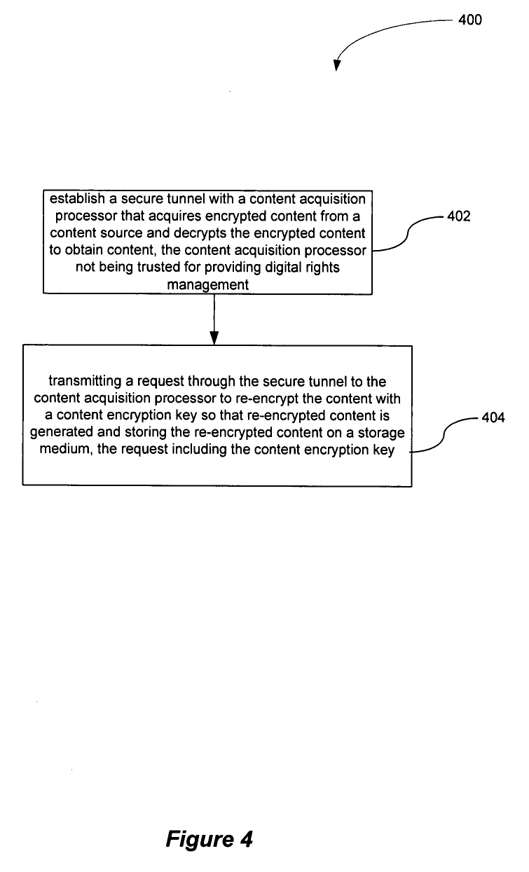

FIG. 4 illustrates a process 400 that may be utilized by a DRM processor 204. At a process block 402, the process 400.establishes a secure tunnel with a content acquisition processor 202 that acquires encrypted content from a content source 102 and decrypts the encrypted content to obtain content. The content acquisition processor 202 is not trusted for providing digital rights management. Further, at a process block 404, the process 400 transmits a request through the secure tunnel to the content acquisition processor 202 to re-encrypt the content with a content encryption key so that re-encrypted content is generated and stores the re-encrypted content on a storage medium. The request including the content encryption key.

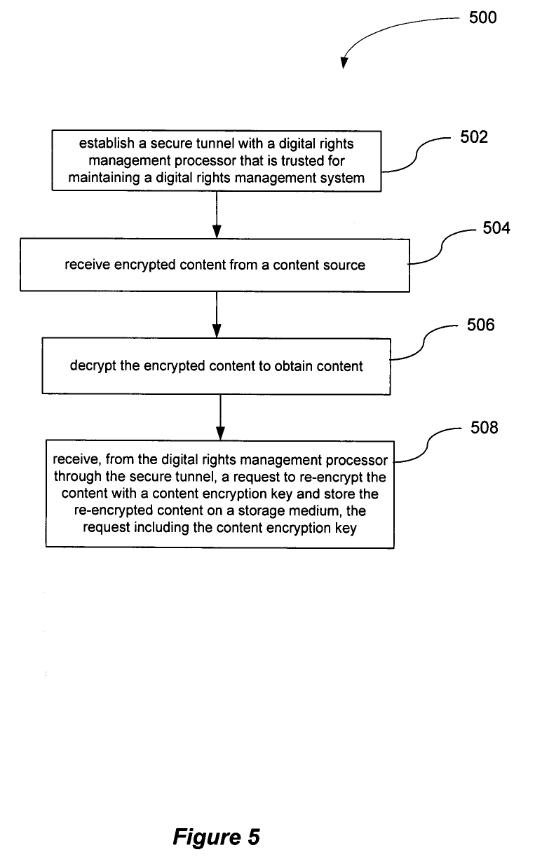

FIG. 5 illustrates a process 500 that may be utilized by a content acquisition processor 202. At a process block 502, the process 500 establishes a secure tunnel with a DRM processor 204 that is trusted for maintaining a digital rights management system. Further, at a process block 504, the process 500 receives encrypted content from a content source 102. In addition, at a process block 506, the process 500 decrypts the encrypted content to obtain content. Finally, at a process block 508, the process 500 receives, from the DRM processor 204 through the secure tunnel, a request to re-encrypt the content with a content encryption key and stores the re-encrypted content on a storage medium, the request including the content encryption key

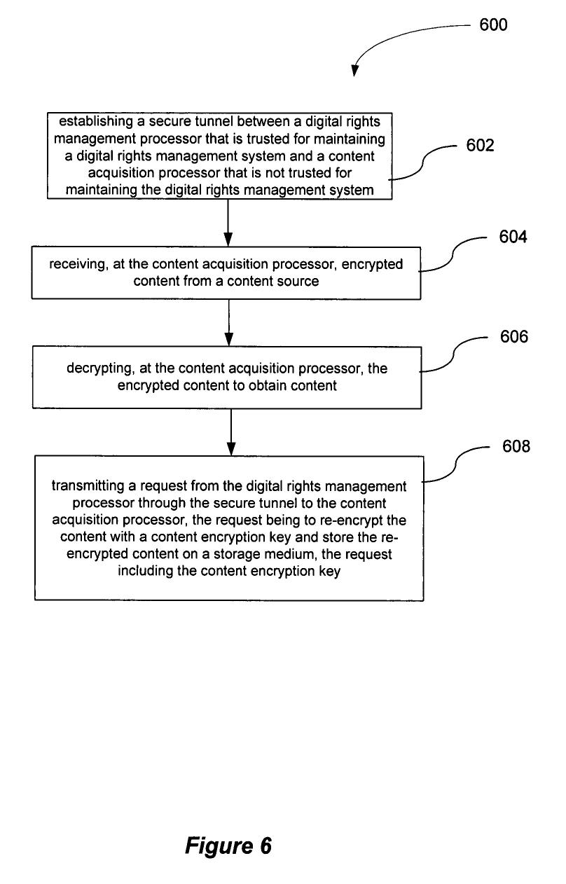

FIG. 6 illustrates a process 600 that may be utilized by the set top box 104. At a process block 602, the process 600 establishes a secure tunnel between a DRM processor 204 that is trusted for maintaining a digital rights management system and a content acquisition processor 202 that is not trusted for maintaining the digital rights management system. Further, at a process block 604, the process 600 receives, at the content acquisition processor, encrypted content from a content source 102. In addition, at a process block 606, the process 600 decrypts, at the content acquisition processor 202, the encrypted content to obtain content. Finally, at a process block 608, the process 600 transmits a request from the DRM processor 204 through the secure tunnel to the content acquisition processor 202. The request is to re-encrypt the content with a content encryption key and store the re-encrypted content on a storage medium, the request including the content encryption key.

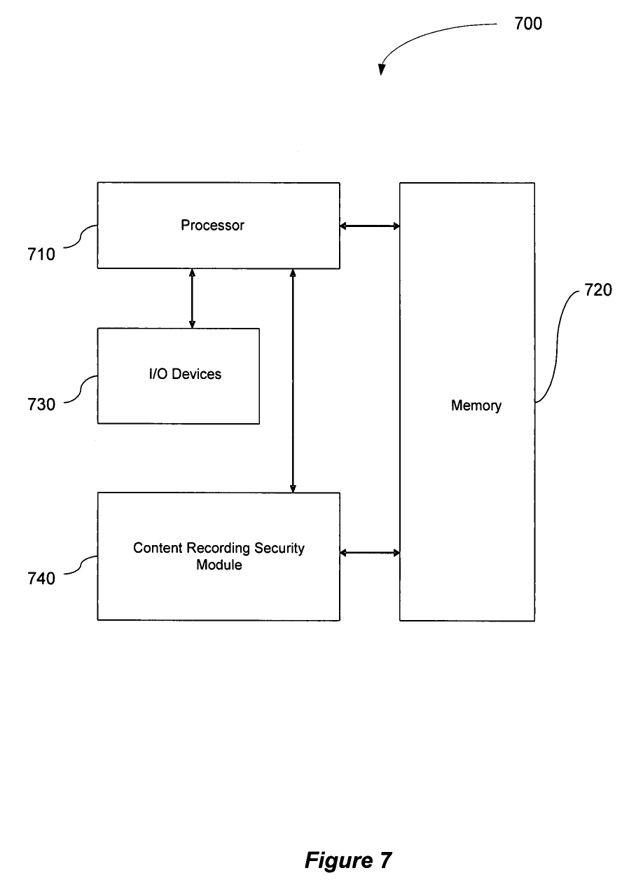

FIG. 7 illustrates a block diagram of a station or system 700 that provides secure content recording. In one embodiment, the station or system 700 is implemented using a general purpose computer or any other hardware equivalents. Thus, the station or system 700 comprises a processor 710, a memory 720, e.g., random access memory (“RAM”) and/or read only memory (ROM), a content recording security module 740, and various input/output devices 730, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)). The content recording security module 740 may include one or more processors, e.g., the content acquisition processor 202 and the DRM processor 204, and/or corresponding code.

It should be understood that the enhanced security module 740 may be implemented as one or more physical devices that are coupled to the processor 710 through a communication channel. Alternatively, the content recording security module 740 may be represented by one or more software applications (or even a combination of software and hardware, e.g., using application specific integrated circuits (ASIC)), where the software is loaded from a storage medium, (e.g., a magnetic or optical drive or diskette) and operated by the processor in the memory 720 of the computer. As such, the content recording security module 740 (including associated data structures) of the present disclosure may be stored on a computer readable medium, e.g., RAM memory, magnetic or optical drive or diskette and the like.

It is understood that the secure content recording approach described herein may also be applied in other types of systems. Those skilled in the art will appreciate that the various adaptations and modifications of the embodiments of this method and apparatus may be configured without departing from the scope and spirit of the present method and system. Therefore, it is to be understood that, within the scope of the appended claims, the present method and apparatus may be practiced other than as specifically described herein. We claim:

1. A method comprising:
establishing a secure tunnel with a content acquisition processor that acquires encrypted content from a content source and decrypts the encrypted content to obtain content, the content acquisition processor not being trusted for providing digital rights management; and
transmitting a request through the secure tunnel to the content acquisition processor to re-encrypt the content with a content encryption key so that re-encrypted content is generated and store the re-encrypted content on a storage medium, the request including the content encryption key.

2. The method of claim 1, wherein the content source includes a content protection module.

3. The method of claim 1, further comprising generating the content encryption key through a digital rights management system.

4. The method of claim 1, further comprising loading encrypted code having a global key and accessing long-term keys stored in the device by decrypting the long-term keys with the global key in the code.

5. The method of claim 4, wherein the long-term keys stored in the device have to first be decrypted using a device-unique key before decrypting the long-term keys the second time with the global key in the code.

6. The method of claim 3, wherein the establishing of the secure tunnel includes determining a shared secret key through a key agreement algorithm, the shared secret key being utilized to encrypt or decrypt one or more messages communicated with the content acquisition processor.

7. The method of claim 6, wherein the establishing of the secure tunnel further comprises authenticating the shared secret with a pre-shared key.

8. The method of claim 7, wherein the pre-shared key is one of the long-term keys stored in the device and is encrypted with the global key in the code and then encrypted with the device-unique key.

9. The method of claim 7, further comprising authenticating the shared secret by determining if the content acquisition processor is running an outdated version of software.

10. The method of claim 8, further comprising preventing communication with the content acquisition processor if the outdated version of software is running on the content acquisition processor.

11. The method of claim 1, further comprising receiving a copy control information update from the content acquisition processor.

12. The method of claim 11, further comprising generating, in response to the copy control information update, a new content encryption key and sending the new content encryption key to the content acquisition processor to re-encrypt the content.

13. The method of claim 12, further comprising receiving copy control information, sending a new content encryption key to the content acquisition processor, and invaliding a content license associated with the content if an acknowledgement of delivery for the new content encryption key is not received within a predetermined time.

14. A method comprising:
establishing a secure tunnel with a digital rights management processor that is trusted for maintaining a digital rights management system;
receiving encrypted content from a content source;
decrypting the encrypted content to obtain content; and
receiving, from the digital rights management processor through the secure tunnel, a request to re-encrypt the content with a content encryption key and store the re-encrypted content on a storage medium, the request including the content encryption key.

15. The method of claim 14, wherein the content source includes a content protection module.

16. The method of claim 14, wherein the establishing of the secure tunnel includes determining a shared secret key through a key agreement algorithm, the shared secret key being utilized to encrypt or decrypt one or more messages communicated with the digital rights management processor.

17. The method of claim 16, wherein the establishing of the secure tunnel further comprises authenticating the shared secret with a pre-shared key.

18. The method of claim 14, further comprising receiving a copy control information update, sending the copy control information update to the digital rights management processor, and halting recording if a new content encryption key is not received within a predetermined time.

19. A method comprising:
establishing a secure tunnel between a digital rights management processor that is trusted for maintaining a digital rights management system and a content acquisition processor that is not trusted for maintaining the digital rights management system;
receiving, at the content acquisition processor, encrypted content from a content source;
decrypting, at the content acquisition processor, the encrypted content to obtain content; and
transmitting a request from the digital rights management processor through the secure tunnel to the content acquisition processor, the request being to re-encrypt the content with a content encryption key and store the re-encrypted content on a storage medium, the request including the content encryption key.

20. The method of claim 19, wherein the content encryption key is generated through a digital rights management system.
